(19) United States
(12) Patent Application Publication
(10) Pub. No.: US 2010/0138473 A1
(43) Pub. Date: Jun. 3, 2010

(54) COMMUNICATION APPARATUS OF APPLICATION FOR SERVING COMMUNICATION OF RELAY NODE AND METHOD OF THE SAME

(75) Inventors: Sangchul Oh, Daejeon-City (KR); Namhoon Park, Daejeon-City (KR)

Correspondence Address: RABIN & Berdo, PC, 1101 14TH STREET, NW, SUITE 500, WASHINGTON, DC, 20005, US

(73) Assignee: ELECTRONICS AND TELECOMMUNICATIONS RESEARCH INSTITUTE, Daejeon-City (KR)

(21) Appl. No.: 12/629,832

(22) Filed: Dec. 2, 2009

(30) Foreign Application Priority Data
Dec. 3, 2008 (KR) 10-2008-0121643
Apr. 13, 2009 (KR) 10-2009-0031963

(51) Int. Cl. G06F 15/16

(52) U.S. Cl. 709/202

(57) ABSTRACT

Provided are a communication apparatus of an application for serving communication of a relay node and a method thereof, includes: a plurality of component groups that are configured to perform work by at least one built-in component and correspond to each plurality of different applications; and an assembly controller that outputs control signals to at least one of the plurality of component groups, the plurality of component groups being packaged by setting the connection between each component group. With this, in fabricating application for serving the communication of the relay node that simultaneously needs at least two applications, the application package in a type where each application is combined can be simply and easily fabricated while using the existing application package as it is and since the present invention uses the existing application package as it is, it can perform the applications alone without modifying each application.

### RELATED APPLICATIONS

The present application claims priority to Korean Patent Application Serial Number 10-2008-0121643, filed on Dec. 3, 2008 and Korean Patent Application Serial Number 10-2009-0031963, filed on Apr. 13, 2009, the entirety of which are hereby incorporated by reference.

### BACKGROUND OF THE INVENTION

1. Field of the Invention

The present invention relates to a communication apparatus of an application for serving communication of a relay node and a method thereof, and in particular, to a communication apparatus of application for serving communication of a relay node that can perform communication of a relay node by designing an application package where a plurality of applications are combined and a method thereof.

2. Description of the Related Art

A Software Communication Architecture (SCA) is a standardized communication software structure to largely improve interoperability between communication systems and to reduce development and distribution costs, which was proposed by Joint Tactical Radio System (JTRS) Joint Program Office (JPO), USA.

The SCA adopts a real time operating system (OS) and a Common Object Request Broker Architecture (CORBA), which is an industrial standard of a distributed object model, as middleware to provide an integrated environment for different types of hardware and software. Herein, the SCA is an independent system design framework rather than a standardized system limited to a specific system.

The SCA binds several components into one package by application that performs one waveform function and installs and arranges it in hardware and then operates it. A representative example adopting the SCA may include an SDR system. The SDR system adopts the SCA as a standard of a software framework.

The application having the SCA structure basically manages the operations of install, instantiation, start, stop, shutdown, uninstall, etc., in one application level. Therefore, it is difficult to apply the foregoing application to a wired and wireless relay node that needs at least two applications.

Of course, a relay application package fabricated after unbinding the software package of two or more applications and newly defining the connection relationship with all the components existing therein can be applied to the wired and wireless relay node. However, this has a problem in that a process of fabricating a separate application package is complicated and difficult.

### SUMMARY OF THE INVENTION

In order to solve the above problem of the related art, it is an object of the present invention to provide a communication apparatus of an application for serving communication of a relay node capable of easily and simply fabricating application of serving communication of a relay node by proposing a new application package as a type where a plurality of applications are combined while maintaining a configuration of each application as it is, and a method thereof.

In order to achieve the above object, there is provided a communication apparatus of an application for serving communication of a relay node, including: a plurality of component groups that are configured to perform work by at least one built-in component and correspond to each plurality of different applications; and an assembly controller that outputs control signals to at least one of the plurality of component groups, the plurality of component groups being packaged by setting the connection between each component group.

In the plurality of component groups, each component group is set to be connected to each other, based on a domain profile where configuration information and connection information on the corresponding application communicating apparatus are defined.

The domain profile includes profile information on each of the plurality of component groups. The domain profile is prepared with an extensible markup language (XML) file.

The component further includes internal input ports and internal output ports to connect to other components of applications corresponding to the corresponding component groups and external input ports and external output ports to connect to components of applications corresponding to other component groups.

The external input ports each correspond to the external output ports built in other component groups and the external output ports one-to-one correspond to the external input ports built in other component groups.

In order to achieve the above object, there is provided a communication apparatus for an application for serving communication of a relay node according to the present invention, including: a component package that includes a plurality of component groups with at least one built-in component; a domain profile where profile information on the component package is defined; and a combined application factory that configures the component package based on the domain profile, the component groups corresponding to each of a plurality of different applications, the component package being packaged by being set to be connected between the plurality of component groups according to the connection information provided from the combined application factory.

The domain profile includes profile information on each of the plurality of component groups.

The communication apparatus further includes a plurality of application factories that correspond to each of the plurality of component groups and configures the corresponding component groups based on the profile information included in the domain profile.

The combined application factory transfers the profile information obtained from the domain profile to each of the application factories corresponding to the plurality of component groups.

In order to achieve the above object, there is provided a communication method of application for serving communication of a relay node, comprising: configuring a plurality of component groups with at least one built-in component; packaging the plurality of component groups by setting the connection between the plurality of component groups based on profile information defined in the domain profile; and performing communication between the plurality of component groups by the connection set between the plurality of component groups, the plurality of component groups corresponding to each plurality of different applications.

The domain profile is defined configuration information and connection information on each of the plurality of component groups.

The domain profile is prepared with an extensible markup language (XML) file.

The packaging includes obtaining the connection information between the plurality of component groups from the domain profile.

The packaging further includes setting the connection between components built in the plurality of component groups; and setting the connection between a component built in any one of the plurality of component groups and a component built in another component group.

The setting the connection is set so that input ports of the components built in each component group each correspond to output ports thereof.

With the present invention, in fabricating the application for serving communication of the relay node that simultaneously needs at least two applications, the application package of a type where each application is combined can be simply and easily fabricated while using the existing application package as it is.

Further, since the present invention uses the existing application package as it is, it can perform the applications alone without modifying each application.

### BRIEF DESCRIPTION OF THE DRAWINGS

FIG. 1 is a diagram showing a SCA structure applied to the present invention;

FIG. 2 is a diagram showing a relay node structure applied to the present invention;

FIG. 3 is a block diagram showing a configuration of a communication apparatus of application according to the embodiment of the present invention;

FIG. 4 is a diagram showing a profile structure of combined application according to the embodiment of the present invention; and

FIGS. 5 to 7 are flowcharts illustrating an operational flow of a communication method of application according to one embodiment of the present invention.

### DETAILED DESCRIPTION OF THE PREFERRED EMBODIMENTS

Hereinafter, exemplary embodiments of the present invention will be described with reference to the accompanying drawings.

The present invention relates to a communication apparatus of an application for serving communication of a relay node and a method thereof. The embodiment to be described below describes an example of providing communication of a relay node in an application based on an SCA structure.

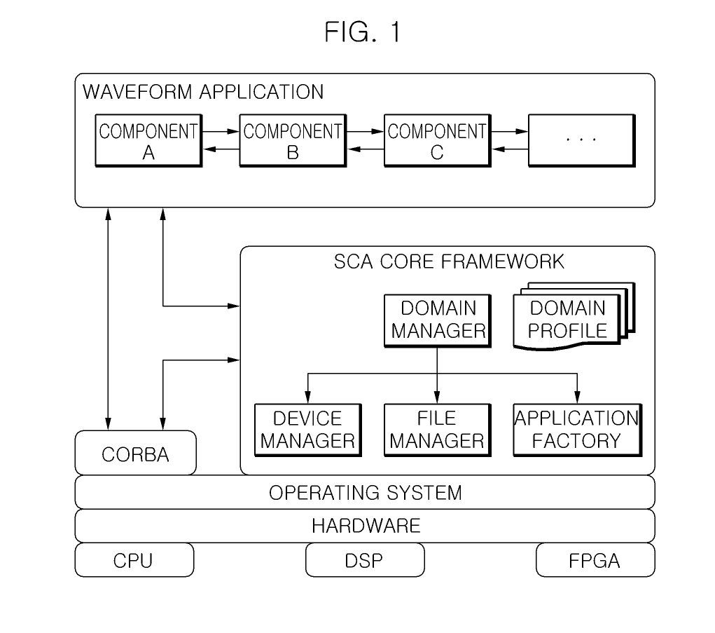

First, FIG. 1 shows an SCA basic structure. The relationship of the applications in the SCA structure will be described with reference to FIG. 1.

In the Software Communications Architecture (SCA) structure, an Operating System (OS), a Common Object Request Broker Architecture (CORBA), and an SCA Core Framework (CF) are disposed on an upper layer of hardware, such as a Central Processing Unit (CPU), a Digital Signal Processor, or a Field Programmable Gate Array (FPGA).

Herein, managers such as a domain manager, a device manager, a file manager, and an application factory and a domain profile in an XML file type exist in the SCA core framework.

Several managers of the SCA core framework arrange the plurality of components of an upper application based on the domain profile in the corresponding hardware and executes them. At this time, each component uses the corresponding ports depending on the connection setting defined in the SCA to transmit and receive therebetween. The connection of each component is set in one way and connection setting information and port information corresponding thereto between each component is defined in the XML file type in the domain profile.

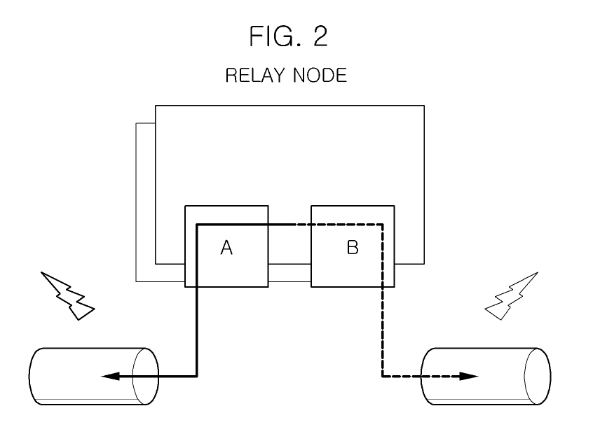

FIG. 2 schematically shows a communication structure using a wired and wireless relay node. As shown in FIG. 2, the wired and wireless relay node transfers signals and data input from a first device A to a second device B and on the contrary, transfers signals and data input from the second device B to the first device A, on a communication system. Herein, the first device A and the second device B are devices that can be communicated in a wired or wireless scheme. Further, the signals and data input and output to and from the first device A may be the same or different mode as the signals and data input and output from the second device B. In the embodiment of FIG. 2, the first device A and the second device B have the same line thickness, but illustrate only one embodiment. As a result, the embodiment is not limited thereto.

Therefore, the first device A and the second device B is not limited to a repeater, a bridge, a router, a gateway, etc.

In the SCA structure of the present invention, when the applications are arranged in hardware, an application package, which can be applied to a relay node requiring at least two applications, is suggested.

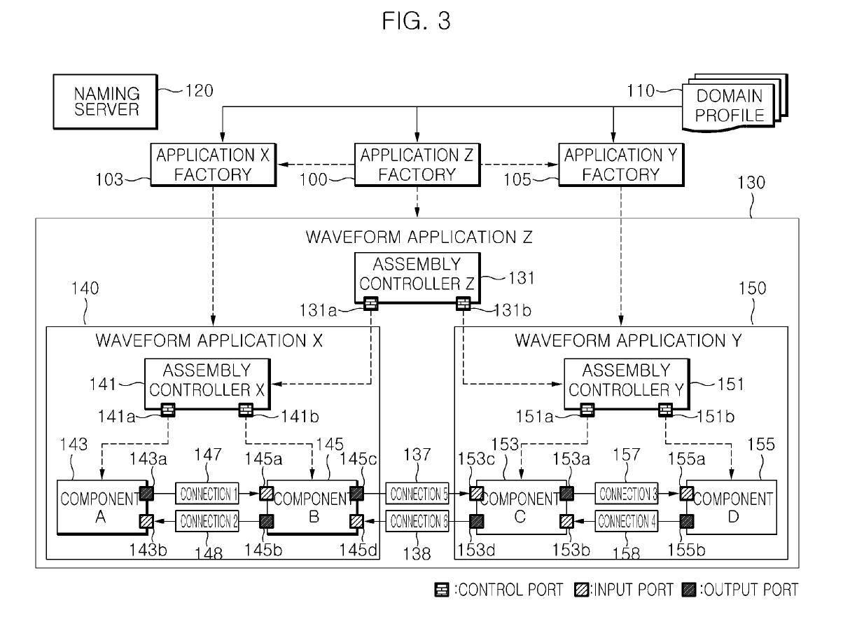

FIG. 3 shows a structure of the application according to the embodiment of the present invention. In particular, FIG. 3 shows a structure of a combined application package proposed in the present invention.

Referring to FIG. 3, the combined application package includes an application X 140 and an application Y 150 and includes an application Z 130 that is a combined application of a type where the application X 140 and the application Y 150 are combined with each other. In other words, the application package of a type where the application X 140 and the application Y 150 are combined by the application Z 130 is formed. Of course, each application factory is provided corresponding to the application X 140, the application Y 150, and the application Z 130 on the SCA structure.

At this time, the component group claimed in the claims of the present invention corresponds to each application, that is, the application X 140 and the application Y 150. Herein, each application controls the driving of components built in the component groups corresponding to the corresponding applications. The embodiment of the present invention describes, by way of example, one of the component groups included in the corresponding applications. The following description does not describe the component group separately but describes, by way of example, but how the components built in the corresponding group are included in the applications.

The configuration of the application X 140 and the application Y 150 has the same configuration as a general application.

In other words, the application X 140 is configured to include the application X factory 103 of the SCA core framework and the application X factory 103 configures and drives the application X 140 based on the profile information of the application X 140 defined in the domain profile 110. However, in the combined application package structure of the present invention, the application X factory 103 receives the profile information of the application X 140 from the application Z factory 100. Herein, the application Z factory 100 is an combined application factory defined in the claims.

The application X 140 includes an assembly controller X 141 and a plurality of components. The assembly controller X 141 sets the connection of each component in the application X 140 and outputs signals that controls the driving of each component. At this time, the assembly controller X 141 includes control ports 141a and 141b that outputs control signals to the components, wherein the control ports 141a and 141b are provided to correspond to each component.

Each component includes an internal input port and an output port for communicating with other components in the application X 140. Meanwhile, at least one of the plurality of components in the application X 140 includes an external input port and an external output port for communicating with components included in other applications.

FIG. 3 shows, by way of example, one that a component A 143 and a component B 145 are provided in the application X 140. However, the number of components is not limited thereto. The component A 143 includes an input port 143b and an output port 143a for communicating with the component B 145 in the application X 140. The component B 145 includes an input port 145a and an output port 145b for communicating with the component A 143 in the application X 140. Meanwhile, the component B 145 includes an external input port 145d and an external output port 145c for communicating with components in other applications.

At this time, in the application X 140, the assembly controller X 141 sets ‘connection 1’ 147 between the output port 143a of the component A 143 and the input port 145a of the component B 145 based on the connection information of the application X 140. In addition, the assembly controller X 141 sets ‘connection 2’ 148 between the output port 145b of the component B 145 and the input port 143b of the component A 143. At this time, each component, that is, the component A 143 and the component B 145 maintain the setting information of ‘the connection 1’ 147 and ‘the connection 2’ 148. Therefore, the component A 143 can transmit signals to the component B 145 through ‘the connection 1’ 147 and the component B 145 can transmit signals to the component A 143 through ‘the connection 2 148’.

Meanwhile, the application Y 150 is configured to include the application Y factory 105 of the SCA core framework and the application Y factory 105 configures and drives the application Y 150 based on the profile information of the application Y 150 defined in the domain profile 110. However, in the combined application package structure of the present invention, the application Y factory 105 receives the profile information of the application Y 150 from the application Z factory 100. The application Y 150 includes an assembly controller Y 151 and a plurality of components. The assembly controller Y 151 sets the connection of each component in the application Y 150 and outputs signals that control the driving of each component. At this time, the assembly controller Y 151 includes control ports 151a and 151b that outputs control signals to the components, wherein the control ports 151a and 151b are provided to correspond to each component.

The component includes an internal input port and an output port for communicating with other components within the application Y 150. Meanwhile, at least one of the plurality of components in the application Y 150 includes an external input port and an external output port for communicating with components included in other applications.

FIG. 3 shows, by way of example, how a component C 153 and a component D 155 are provided in the application Y 150. However, the number of components is not limited thereto. The component C 153 includes an input port 153b and an output port 153a for communicating with the component D 155 in the application Y 150. The component D 155 includes an input port 155a and an output port 155b for communicating with the component C 153 in the application Y 150. Meanwhile, the component C 153 includes an external input port 153c and an external output port 153d for communicating with the component B 145 in another application, that is, the application X 140.

At this time, in the application Y 150, the assembly controller Y 151 sets ‘connection 3’ 157 between the output port 153a of the component C 153 and the input port 155a of the component D 155 based on the profile information of the application Y 150. In addition, the assembly controller Y 151 sets ‘connection 4’ 158 between the output port 155b of the component D 155 and the input port 153b of the component C 153. At this time, each component, that is, the component C 153 and the component D 155 maintain the setting information of ‘the connection 3’ 157 and ‘the connection 4’ 158. Therefore, the component C 153 can transmit signals to the component D 155 through ‘the connection 3’ 157 and the component D 155 can transmit signals to the component C 153 through ‘the connection 4’ 158.

Meanwhile, the application Z 130 is configured to include the application Z factory 100 of the SCA core framework and the application Z factory 100 configures and drives the application Z 130 based on the profile information of the application Z 130 defined in the domain profile 110. At this time, the profile information of the application Z 130 includes the configuration information and connection information of the application Z 130. In addition the profile information of the application Z 130 includes the profile information of the application X 140 and the application Y 150.

Therefore, the application Z factory 100 transmits the profile information of the application X 140 obtained by parsing the profile information of the application Z 130 to the application X factory 103 and transmits the profile information of the application Y 150 to the application Y factory 105.

The application Z 130 includes the assembly controller Z 131. At this time, the application Z 130 includes the application X 140 and the application Y 150.

The assembly controller Z 131 controls the driving of the application X 140 and the application Y 150 that are included in the application Z 130. In addition, the assembly controller Z 131 sets the connection between the application X 140 and the application Y 150. In other words, the assembly controller Z 131 sets the connection between the external input port 145d and the external output port 145c of the component B 145 in the application X 140 and the external input port 153c and the external output port 153d of the component C 153 in the application Y 150 according to the configuration information of the application Z 130.

At this time, the assembly controller Z 131 sets ‘connection 5’ 137 between the external output port 145c included in the component B 145 of the application X 140 and the external input port 153c of the component C 153 included in the application Y 150. Further, the assembly controller Z 131 sets ‘connection 6’ 138 between the external output port 153d included in the component C 153 of the application Y 150 and the external input port 145d of the component B 145 included in the application X 140.

Therefore, when transmitting signals from the application X 140 to the application Y 150, the application X 140 transmits the signals to the external output port 145c of the component B 145, such that the signals transmitted from the component B 145 are input from the application Y 150 to the external input port 153c of the component C 153. Meanwhile, when transmitting signals from the application Y 150 to the application X 140, the application Y 150 transmits the signals to the external output port 153d of the component C 153, such that the signals transmitted from the component C 153 are input from the application X 140 to the external input port 145d of the component B 145.

The communication between the application X 140 and the application Y 150, which are different applications, can be achieved.

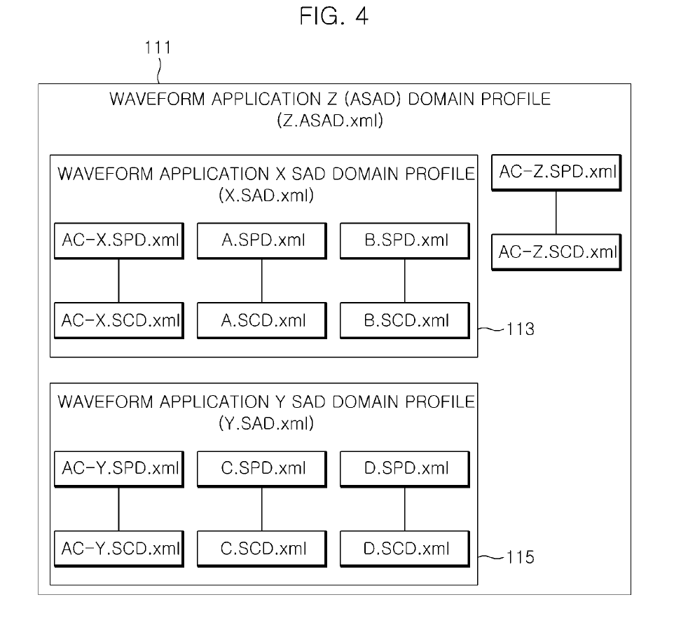

FIG. 4 shows the profile structure of the combined application package defined in the SCA based domain profile according to the present invention and shows in detail the profile structure of the application Z.

Referring to FIG. 4, the profile of the application z 130 is defined in the domain profile 110 in the xml file format. Herein, the case where the profile of the application Z 130 is Z.ASAD.xml 111 will be described as an example. Herein, ASAD is an abbreviated word for Aggregate Software Assembly Descriptor (SAD) and the Software Assembly Descriptor (SAD) file includes information on components configuring application.

The Z.ASAD.xml 111 includes AC-Z.SPD.xml and AC-Z.SCD.xml that includes assembly controller information (AC-Z) on the application Z 130. Herein, the Software Package Descriptor (SPD) file includes information for identifying the implementation object of the unit software component. Further, the Software Component Descriptor (SCD) file includes information on an interface that is provided and used by the component. For example, the AC-Z.SCD.xml includes the interface information of the component B and the component C in FIG. 3. At this time, the Z.ASAD.xml 111 includes the connection information of the component B 145 and the component C 153, that is, the connection information and the port information, etc. on ‘the connection 5’ 137 and ‘the connection 6’ 138 in the application Z 130.

Meanwhile, the Z.ASAD.xml further includes an X.SAD.xml 113 that is the profile of the application X 140 and a Y.SAD.xml 115 that is a profile of the application Y 150.

The X.SAD.xml 113 that is the profile of the application X 140 includes AC-X.SPD.xml and AC-X.SCD.xml that are information on the assembly controller X 141 of the application X 140. Further, the X.SAD.xml 113 includes the component information that is included in the application X 140. Describing the case of FIG. 3 as an example, the X.SAD.xml 113 includes the A.SPD.xml and A.SCD.xml that is the information of the component A 143 and includes B.SPD.xml and B.SCD.xml that are the information of the component B 145.

Meanwhile, the Y.SAD.xml 115 that is the profile of the application Y 150 includes AC-Y.SPD.xml and AC-Y.SCD.xml that are information on the assembly controller Y 151 of the application Y 150. Further, the Y.SAD.xml 115 includes the component information that is included in the application Y 150. Describing the case of FIG. 3 as an example, the Y.SAD.xml 115 includes the C.SPD.xml and C.SCD.xml that is the information of the component C 153 and includes D.SPD.xml and D.SCD.xml that are the information of the component D 155.

Therefore, if Z.ASAD.xml 111 that is the profile of the application Z 130 defined in the domain profile 110 is parsed by the application Z factory 100, the configuration information of the application Z 130 as well as the profile information of the application X 140 and the application Y 150 are also obtained.

The operational flow of the present invention configured as above will be described.

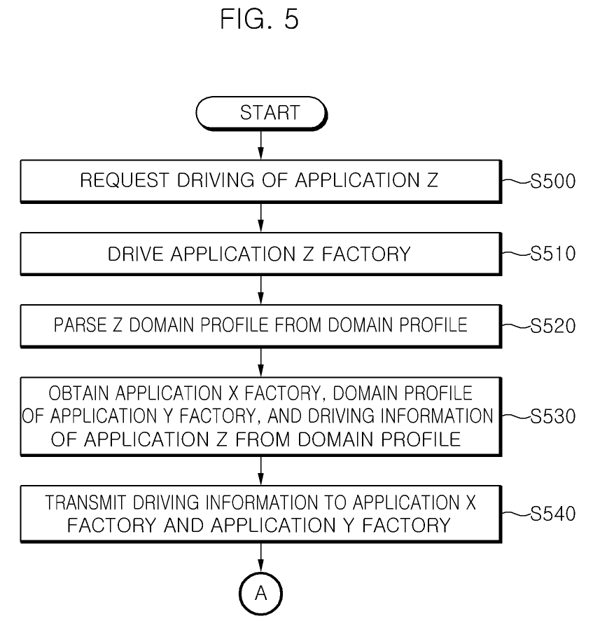

FIG. 5 is a flowchart showing the operational flow of the combined application package according to the present invention.

Referring first to FIG. 5, if the driving request of the application Z 130 is input from the outside (S500), the application Z factory 100 is driven (S510). At this time, the application Z factory 100 parses the profile of the application Z 130 defined in the domain profile 110 (S520) and the profiles of the application X 140 and application Y 150 are obtained from the profile of the parsed application Z 130. Further, the application Z factory 100 obtains the configuration information of the application Z 130 from the profile of the parsed application Z 130, that is, obtains the information of the assembly controller Z 131 and the connection information of the application Z 130 (S530).

The application Z factory 100 configures the application Z 130 based on the configuration information of the obtained application Z 130. Meanwhile, the application Z factory 100 transmits the profile of the obtained application X 140 to the application X factory 103 and transmits the profile of the application Y 150 to the application Y factory 105, respectively (S540).

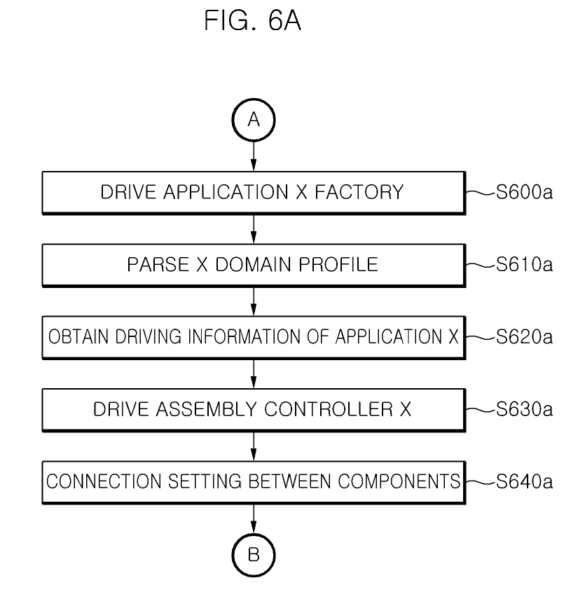

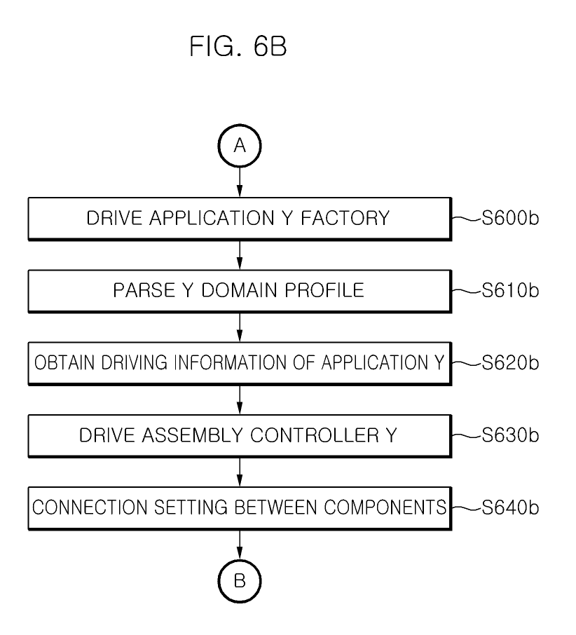

Thereafter, the application X factory 103 and the application B factory receiving the profile from the application Z factory 100 are each subjected to processes of FIGS. 6a and 6b.

First, as shown in FIG. 6a, the application X factory 103 is driven by the application Z factory 100 (S600a). At this time, the application X factory 103 parses the profile transmitted from the application Z factory 100 (S610a) and obtains the configuration information of the application X 140 from the profile of the parsed application X 140 (S620a). Herein, the configuration information of the application X 140 includes the information of the assembly controller X 141 and the internal connection information of the application X 140.

Therefore, the application X factory 103 configures the application X 140 according to the configuration information of the obtained application X 140 (S630a). At this time, the application X 140 sets the connection between components in the application X 140 according to the configuration information (S640a).

Therefore, the components inside the application X 140 exchanges predetermined information according to the connection setting at this time, the connection of each component is set in one way and the information exchange can be performed only between the connection set components.

As shown in FIG. 6b, the application Y factory 105 is driven by the application Z factory 100 (S600b). At this time, the application Y factory 105 parses the profile transmitted from the application Z factory 100 (S610b) and obtains the configuration information of the application Y 150 from the profile of the parsed application Y 140 (S620b). Herein, the configuration information of the application Y 150 includes the information of the assembly controller Y 151 and the internal connection information of the application Y 150.

Therefore, the application Y factory 105 configures the application Y 150 according to the configuration information of the obtained application Y 150 (S630b). At this time, the application Y 150 sets the connection between components in the application Y 150 according to the configuration information (S640b).

Therefore, the components inside the application Y 150 exchanges predetermined information according to the connection setting. At this time, the connection of each component is set in one way and the information exchange can be performed only between the connection set components.

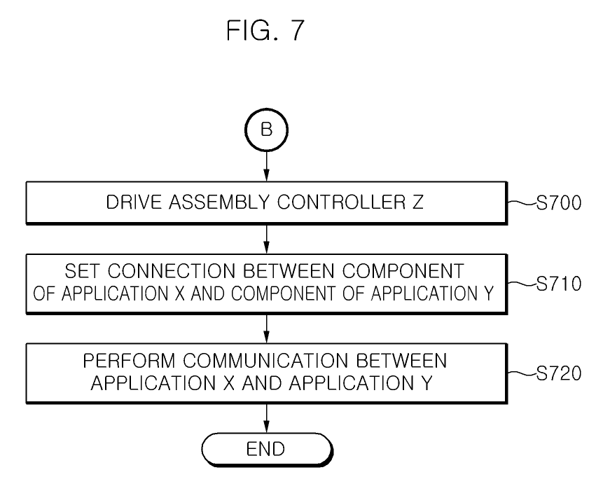

After performing the process of FIGS. 6a and 6b, the application Z 130 performs processes subsequent to ‘B’ of FIG. 7. As shown in FIG. 7, if both the application X 140 and the application Y 150 are configured, the application Z 130 sets the connection between the application X 140 and the application Y 150 according to the connection information of the application Z 130. In other words, the application Z 130 sets the connection between the components in the application X 140 and the components in the application Y 150.

Therefore, the application X 140 and the application Y 150 exchange the predetermined information according to the connection set of the application Z 130. Likewise, the connection of each component is set in one way and the information exchange can be performed only between the connection set components.

As described above, the communication apparatus of application for serving communication of a relay node and the method thereof according to the present invention is not limited to the configuration and method of the embodiments described as above, but the embodiments may be configured by selectively combining all the embodiments or some of the embodiments so that various modifications can be made.

What is claimed is:

1. A communication apparatus of an application for serving communication of a relay node, comprising;
a plurality of component groups that are configured to perform work by at least one built-in component and correspond to each plurality of different applications; and
an assembly controller that outputs control signals to at least one of the plurality of component groups, the plurality of component groups being packaged by setting the connection between each component group.

2. The communication apparatus of an application for serving communication of a relay node according to claim 1, wherein in the plurality of component groups, each component group is set to be connected to each other, based on a domain profile where configuration information and connection information on the corresponding application communicating apparatus are defined.

3. The communication apparatus of an application for serving communication of a relay node according to claim 2, wherein the domain profile includes profile information on each of the plurality of component groups.

4. The communication apparatus of an application for serving communication of a relay node according to claim 2, wherein the domain profile is prepared with an extensible markup language (XML) file.

5. The communication apparatus of an application for serving communication of a relay node according to claim 1, wherein the component further includes internal input ports and internal output ports to connect to other components in applications corresponding to the corresponding component groups and external input ports and external output ports to connect to components in applications corresponding to other component groups.

6. The communication apparatus of an application for serving communication of a relay node according to claim 5, wherein the external input ports each correspond to the external output ports built in other component groups and the external output ports each correspond to the external input ports built in other component groups.

7. A communication apparatus of an application for serving communication of a relay node, comprising:
a component package that includes a plurality of component groups with at least one built-in component;
a domain profile where profile information on the component package is defined; and
a combined application factory that configures the component package based on the domain profile, the component groups corresponding to each plurality of different applications, the component package being packaged by being set to be connected between the plurality of component groups according to the connection information provided from the combined application factory.

8. The communication apparatus of an application for serving communication of a relay node according to claim 7, wherein the domain profile includes profile information on each plurality of component groups.

9. The communication apparatus of an application for serving communication of a relay node according to claim 8, further comprising a plurality of application factories that correspond to each of the plurality of component groups and configures the corresponding component groups based on the profile information included in the domain profile.

10. The communication apparatus of application for serving communication of a relay node according to claim 7, wherein the combined application factory transfers the profile information obtained from the domain profile to each of the application factories corresponding to the plurality of component groups.

11. A communication method of an application for serving communication of a relay node, comprising:
configuring a plurality of component groups with at least one built-in component;
packaging the plurality of component groups by setting the connection between the plurality of component groups based on profile information defined in the domain profile; and
performing communication between the plurality of component groups by the connection set between the plurality of component groups, the plurality of component groups corresponding to each of the plurality of different applications.

12. The communication method of an application for serving communication of a relay node according to claim 11, wherein the domain profile is defined configuration information and connection information on each of the plurality of component groups.

13. The communication method of an application for serving communication of a relay node according to claim 11, wherein the domain profile is prepared with an extensible markup language (XML) file.

14. The communication method of an application for serving communication of a relay node according to claim 11, wherein the packaging includes obtaining the connection information between the plurality of component groups from the domain profile.

15. The communication method of an application for serving communication of a relay node according to claim 11, wherein the packaging further includes setting the connection between components built in the plurality of component groups; and setting the connection between a component built in any one of the plurality of component groups and a component built in another component group.

16. The communication method of an application for serving communication of a relay node according to claim 15, wherein the setting the connection is set so that input ports of the components built in each component group each correspond to output ports thereof.
